(19) United States
(12) Patent Application Publication
(10) Pub. No.: US 2002/0062251 A1
(43) Pub. Date: May 23, 2002

(54) System and method for wireless consumer communications

(76) Inventors: Rajan Anandan, Chicago, IL (US); Joanna Barsh, New York, NY (US); Gregory B. Gillies, Burlington (CA); Sophia Kim, New York, NY (US)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 09/964,493

(22) Filed: Sep. 28, 2001

Related U.S. Application Data
(60) Provisional application No. 60/236,386, filed on Sep. 29, 2000.

(51) Int. Cl. G06F 17/60

(52) U.S. Cl. 705/14

(57) ABSTRACT

The present invention provides a system and a method for communicating with consumers using wireless technologies. The invention facilitates the tracking of consumer movements within retail locations, collects responses by consumers regarding their experiences in these locations, and distributes location-specific marketing or promotional messages through the use of location-tracking technology and portable electronic communication devices.

### CROSS REFERENCE TO RELATED APPLICATION

This application claims priority to U.S. provisional application No. 60/236,386, filed Sep. 29, 2000, the entirety of which is incorporated herein by reference.

### FIELD OF INVENTION

The present invention relates to the field of consumer research and communications. More particularly, the present invention relates to a system and method for conducting consumer research and marketing using wireless technologies.

### BACKGROUND OF THE INVENTION

Consumer feedback and responses to shopping experiences are valuable tools used by service-oriented businesses, such as the retail, hospitality, financial services, media, and packaged goods industries. The ability to capture simple, timely, and targeted consumer feedback can help businesses improve their financial and operational performance by providing critiques and suggestions for making improvements to specific and overall consumer experiences. The ability to categorize consumer purchases and shopping behavior into various demographic groups can also be very valuable in helping businesses understand their customers. However, service levels and shopping behavior are two key areas where businesses often lack the ability to obtain adequate feedback, and businesses typically have no means to get this type and quality of insight into consumer shopping behavior and preferences. Service levels refer to elements that determine consumer satisfaction. These elements include, but are not limited to, finding desired items in stock, the availability and helpfulness of in-store service staff, and the amount of time it takes to complete a purchase at a checkout counter.

Except for the largest retailers and others who can afford to implement, for example, Interactive Voice Response (IVR) technology to communicate with consumers, businesses typically do not have an economical way to obtain timely feedback on specific store issues. Even IVR systems are susceptible to bias, since it is likely that only shoppers who are very pleased or very displeased with their experience will use a toll-free phone number to register their comments. Furthermore, IVR systems typically do not capture feedback from shoppers who leave a store without making a purchase.

There are other unattractive methods for studying consumer behavior. Techniques such as observing consumers or self-reporting by consumers, however, have their own drawbacks. Observation methods involve watching consumers as they shop, usually capturing their actions on videotape. This method, however, is expensive, may not provide statistically reliable samples, and tends to make consumers feel self-conscious, perhaps affecting their usual behavior. Self-reporting involves interviewing consumers, either one-on-one or in groups. In addition to sample size issues, there are recency concerns, as consumers must recall what they did in the past.

Businesses would also like to know the composition of their customer base. The ability to understand the shopping behavior of different segments of the population can help businesses maximize their marketing potential. However, methods for obtaining consumer demographic information for specific businesses are virtually nonexistent.

For most businesses, obtaining accurate assessments of customer satisfaction is important. Without actionable information concerning consumer shopping habits and behavior categorized by segment (demographic and/or psychographic), businesses are often unable to optimize their resources and make fully informed investments. Research has confirmed that improvements in customer satisfaction scores can lead to success in sales.

For the foregoing reasons, there is a need for an improved means for determining how different consumers shop within and across businesses and for obtaining accurate feedback from a representative sampling of consumers.

### SUMMARY OF THE INVENTION

The present invention is directed to a system and method for communicating with consumers using wireless technologies. In one aspect of the invention, a method is provided for communicating with a consumer by identifying a wireless identification device associated with the consumer at a premises and transmitting a message to a wireless reception device associated with the consumer, the content of the message being responsive to the premises' identity or responsive to the premises' contents. In another aspect of the invention, the method of communicating with a consumer also comprises receiving a response to the message transmitted to the wireless reception device. In further aspects of the invention, the message to the consumer comprises prompts to elicit information from the consumer relating to the premises, a customer satisfaction survey, a product promotion, a link to an Internet page, alphanumeric text, or a voice message.

In another aspect of the invention, the wireless identification device is a Radio Frequency Identification Transponder. In still another aspect of the invention, Radio Frequency Identification Transponder information is transmitted to a central controller. The transmission may be through an Internet service provider or another telecommunications network. The transmission may be facilitated by a local area network that may be enabled with Bluetooth wireless technology.

In another aspect of the invention, a system is provided for communicating with a consumer comprising a wireless identification device associated with the consumer at a premises, a wireless identification device detector to communicate with the wireless identification device, a first computer in communication with the wireless identification device detector for identifying the consumer associated with the wireless identification device, a wireless reception device associated with the consumer, and a second computer in communication with the first computer, for transmitting a message to the wireless reception device, the content of the message being responsive to the premises' identity or responsive to the premises' contents. In another aspect of the invention, the second computer can also receive a response to the message transmitted to the wireless reception device. In further aspects of the invention, the message to the consumer comprises prompts to elicit information from the consumer relating to the premises, a customer satisfaction survey, a product promotion, a link to an Internet page, alphanumeric text, or a voice message.

The invention provides a system and method for essentially real-time detection and identification of consumers entering or exiting a premises. The invention can also detect and identify the movement of consumers throughout the premises. In another aspect of the invention, a system and method are provided for essentially real-time wireless detection and identification of unique and identifiable consumer metrics for remote locations.

In a further aspect of the invention, a system and method are provided for integrating (a) various data communication networks and solutions that facilitate the near real-time messaging between remote location systems and that collect consumer metrics, and (b) one or more centralized processing systems.

In yet another aspect of the invention, a system and method are provided for unintrusively and seamlessly provisioning wireless paging, wireless 1-way or 2-way text messaging, wireless e-mail, or wireless Net-Alerts, containing embedded hot-links or direct navigation options that facilitates the automatic routing of a consumer wireless device to a wireless Internet Uniform Resource Locator (URL) page.

Additional features and advantages of the invention are set forth in part in the description that follows, and in part are apparent from the description, or may be learned by practice of the invention.

### BRIEF DESCRIPTION OF THE DRAWINGS

The accompanying drawings, which are incorporated in and form a part of the specification, illustrate embodiments of the present invention and, together with the description, serve to explain the principles of the invention.

FIG. 1 illustrates a flowchart depicting an embodiment of the decision processes of the present invention;

FIG. 2 illustrates a monitoring infrastructure of an embodiment of the present invention;

FIG. 3 illustrates a data communications configuration of an embodiment of the present invention;

FIG. 4 illustrates data communications configurations of embodiments of the present invention;

FIG. 5 illustrates a wireless data communications configuration of an embodiment of the present invention;

FIG. 6 illustrates a wireless data communications configuration of an embodiment of the present invention utilizing a wireless Local Area Network (LAN);

FIG. 7 illustrates a wireless data communications configuration of an embodiment of the present invention utilizing a Bluetooth-enabled wireless LAN; and

FIG. 8 illustrates a monitoring infrastructure of an embodiment of the present invention.

### DETAILED DESCRIPTION

In describing embodiments of the invention, specific terminology will be used for the sake of clarity. However, the invention is not intended to be limited to the specific terms selected, and it is to be understood that each specific term includes all equivalents.

The present invention provides a system and method for communicating with consumers that utilize wireless location-tracking technology. The location-tracking technology consists of devices installed in consumer-business premises, in industries such as retail, hospitality, and financial services, that recognize when certain portable devices pass by the location-tracking devices. This location-tracking technology, preferably installed at entrances and exits, identifies when a consumer carrying an appropriate portable device enters and exits the establishment. The location-tracking technology may also be installed throughout a consumer-business premises in order to track consumer movement within the premises. According to an embodiment of the present invention, upon entering or exiting the premises of a participating consumer-business, a participating consumer receives an electronic survey, sent either to a wireless portable device or the consumer's personal computer, or both. In another embodiment, the electronic survey is sent to the consumer a predetermined period of time after entering or exiting the premises. The consumer can then complete the survey to provide feedback on his or her experience at the establishment. This information is electronically transmitted back to a central controller, called a Consumer Technology Enabled Panel (CTEP), for aggregation and analysis. The location-tracking technology also enables CTEP to send tailored marketing messages, for example, advertising or promotions, to participating consumers.

In an embodiment, the invention utilizes Radio Frequency Identification (RFID) technology, which can monitor and track the movement of inventory, people, or vehicles or to identify materials, vehicles, livestock, or inventoried items using a wireless interface.

Various RFID configurations exist that could be employed for the CTEP solution, subject to environmental requirements. Most RFID systems include readers/antennas that are used to create monitoring zones of varying size (height, width, and depth) and transponders, also known as Radio Frequency Identification Transponders (tags). In an embodiment, if an appropriately equipped tag enters a monitoring zone and both the reader/antenna and tag share a common communication-identification protocol, the reader/antenna system generates a record containing a reader/antenna-id, a tag-id, and other system and event information appropriate for processing by other systems. In an embodiment, each reader/antenna and each tag is assigned a unique id, making it possible specifically to identify something or someone at a specific location.

The RFID technology can also control the size of the reader/antenna monitoring zone to enable “micro-tracking.” This allows the RFID infrastructure to monitor consumer movements within very small distances. At Point of Sales (POS) terminals, for example, the RFID system can be configured such that a tag would be registered only if it comes within, for example, three inches of the reader/antenna. This would help ensure that only consumers making purchases are identified. This technology can also provide valuable traffic flow information within a premises by strategically placing readers/antennas throughout the premises. The information collected can be used to redesign retail space to improve consumer traffic flow, for example. The information can also be used to collect demographic information concerning consumer traffic flow, for example, such as how many men visited a particular aisle in the premises.

Embodiments of the present invention employ RFID technology as a foundation for monitoring the activities of participating consumers. In embodiments, all consumer entry and exit points at a participating business location are configured with appropriate RFID readers/antennas to create monitoring zones spanning the widths and heights of the access points, with a predetermined depth. Each access point reader/antenna combination is assigned a unique identification code allowing the cross-referencing of each reader/antenna identification code to a specific location. In embodiments, RFID readers/antennas are installed at various locations within a premises to identify consumers passing by those locations.

In an embodiment of the present invention, participating consumers are provided a tag transponder. This tag may be affixed to a portable device provided to consumers selected in advance, i.e., “panel members.” Each tag is assigned a unique identifier, and this identifier is added to a participating consumer's profile data for future cross-referencing. A communication protocol may be established between the readers/antennas and the tags to limit the reading and processing to only CTEP events.

In an embodiment of the present invention, as a tag is brought into a monitoring zone, the tag-id is read, and a record is created to register the location of the event, the participating consumer associated with the tag involved in the event, and the date and time of the event. In an embodiment of the invention, upon registering an entry or exit event, a data transfer process triggers the initiation of an application that, if available, re-uses an existing open Internet connection or, if required, auto-dials a pre-assigned Internet Service Provider (ISP) to launch a new Internet session. Upon establishing an Internet connection, a secure and encrypted data transfer process is triggered, sending the event data to a CTEP system for further processing.

In addition to or instead of the RFID technology, the present invention may also employ an Integrated Wireless Mobile Device and Personal Area Network Technology, or other technologies known to those of skill in the art, to track, at participating sites, the entry, exit, or movement of devices associated with panel members.

In an embodiment of the present invention, upon logging store exit events on the CTEP servers, the CTEP system uses pre-determined decision rules, such as the number of surveys the consumer has completed in the last calendar year or the number of times the consumer has visited a location in the past 30 days, to determine whether the participating consumer should receive a survey. If a participating consumer is selected to receive a survey, in an embodiment of the present invention, an appropriate electronic communication is sent to the consumer immediately or after a predetermined period of time. The type of message sent is based on the consumer's profile and may, for example, be an e-mail containing an embedded hot-link to a survey URL/page sent to the consumer's personal computer or wireless mobile device. The panel member then clicks on or otherwise accesses the hot-link to navigate to the survey URL/page to complete the survey. The message may also be a wireless net-alert containing an embedded hot-link to a survey URL/page sent to the consumer's wireless mobile device. The message may also be a text message using Short Message Service (SMS) messaging instant messaging, or 1-way or 2-way paging, for example. The message may also be an outbound IVR call session sent to either the consumer's wireless mobile phone or wired phone, allowing the consumer to complete a survey using speech recognition and/or touch-tone phone digit input.

In an embodiment, the system of the present invention may also send messages to a participating consumer based on the consumer's location at a particular time. Upon identifying the location of a participating consumer, the system of the present invention uses decision rules, such as the number of promotions the consumer has received for a specific business premises during the last 30 days, to determine if the consumer should receive further marketing messages (e.g., advertising or promotion). If the consumer is selected to receive marketing information, the system sends the appropriate electronic message to the consumer corresponding to the consumer's location at that time. The type of message sent is based on the consumer's profile and may be an e-mail containing an embedded hot-link to a marketing URL/page sent to the consumer's computer or wireless mobile device. The consumer, for example, can click on the hot-link to navigate to a marketing URL/page to view the marketing content and/or respond to offers. The message may also be a wireless net-alert containing an embedded hot-link to the marketing URL/page sent to the panel member's wireless mobile device. The message may also be a text message using SMS messaging or instant messaging, for example. The message may also be an outbound IVR call sent to the panel member's wireless mobile phone containing an audio version of a marketing message. The consumer listens to the audio message and may respond through speech recognition and/or touch-tone phone digit input.

In embodiments, the tag applied to wireless mobile devices can also be used to capture customer purchase information using RFID technology to provide businesses the opportunity to collect demographic information at a POS. In such embodiments, when a customer initiates a purchase transaction, a close-range proximity reader situated at the relevant POS station reads the tag-id assigned to the tag device and signals a central controller in communication with the POS device, for example. In response, the business may issue the customer a discount as an incentive for participating. Businesses can thus collect valuable information by integrating consumer demographic data with customer purchases.

In embodiments of the present invention, participating consumers complete a demographic survey before being assigned transponder tags. Information from the completed surveys is added to the demographic profiles of the participating consumers and can allow businesses to collect data concerning the shopping behaviors and purchases of each participant and of each demographic grouping.

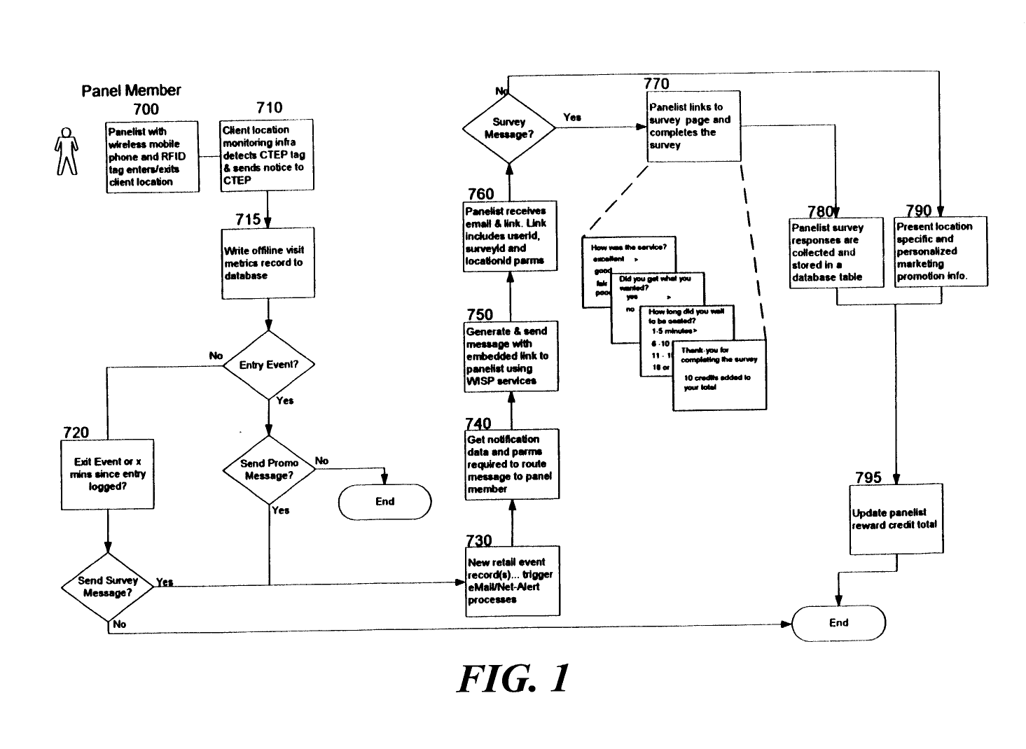

With reference to the drawings, in general, and FIGS. 1 through 8 in particular, embodiments of the present invention are described.

FIG. 1 illustrates a flow diagram of a process of an embodiment of the present invention. In an embodiment of the invention, this process represents a CTEP Retail Event Initiated Wireless Survey Process Flow. The process begins at step 700, when a participating consumer having a wireless mobile device and a corresponding CTEP RFID tag enters or exits a participating business location having the appropriate RFID infrastructure. In step 710, the business' RFID computer system, a component of the RFID infrastructure, which may have Internet access, generates an appropriate record reflecting the event. In embodiments of the invention, the first event recorded for a participating consumer at a participating business location on a given day may be assumed to indicate an entry event. The RFID infrastructure then initiates a secure and authenticated Internet session, or another method of communication, with CTEP and transmits the data to CTEP for processing.

Upon receipt of the first record in step 715, the CTEP system writes the event to a database. The CTEP system, using decision rules, then determines if a marketing promotion message should be generated and sent to the participating consumer. If no message should be sent the process is terminated.

If the event is not the first event recorded for the participating consumer for a particular business location, the process flows to step 720. If it is determined that the event is not a first event, or if a predetermined period of time has elapsed since the recording of the first event without the recording of a corresponding exit event, the system may generate a survey message for the participating consumer. In another embodiment, a promotional message may be sent to the participating consumer upon entering a business premises or after passing through the monitoring zone of a reader/antenna within the premises. A further check is performed to determine if the message should be sent because CTEP is designed to permit a limit on the number of messages sent to one participating consumer. If no message should be sent the process is terminated.

If a message should be sent, in an embodiment of the present invention, CTEP triggers wireless e-mail/Net-Alert processes in step 730. In embodiments, CTEP may initiate the transmission of a text message to the consumer using SMS messaging or instant messaging, for example. In step 740, the e-mail/Net-Alert processes use the data from the event record to query the CTEP consumer profile database in order to establish the notification parameters required to route a notification message. In step 750, CTEP initiates the transmission of a message corresponding to the event to the participating consumer using remote wireless services. Upon receipt of the e-mail/Net-Alert notification, in step 760, the participating consumer reviews the message and uses the embedded hot-links and corresponding parameters (for example, user-id, survey-id, promo-id, and location-id) to navigate directly to the CTEP URL/survey page(s), in step 770, or to the marketing/promotion pages, in step 790.

If the participating consumer is directed to a survey page, after the consumer completes the survey questions presented in step 780, CTEP stores the consumer's survey responses in an appropriate database. If the consumer is sent to the marketing/promotions page, CTEP presents personalized promotional/marketing content to the consumer based on the consumer's present location, demographic profile, and purchasing history. In step 795, whether the consumer completed a survey or was presented with promotional material, CTEP then updates the consumer's profile including, for example, updating reward or other promotional credits.

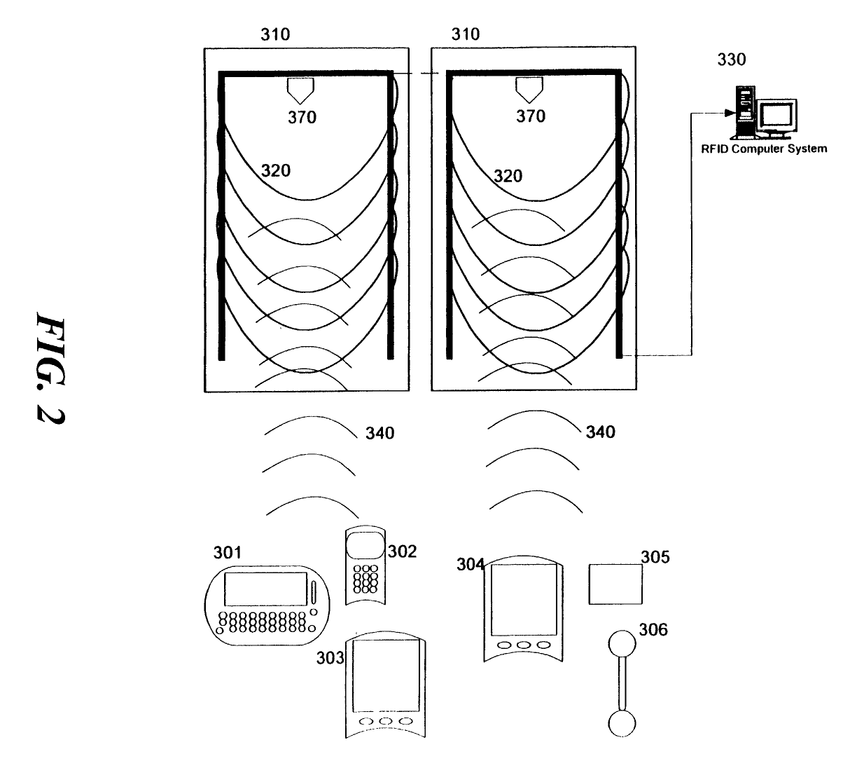

FIG. 2 illustrates a Radio Frequency Identification (RFID) entry/exit monitoring infrastructure configuration of an embodiment of the present invention. In a preferred embodiment, participating consumers have wireless mobile devices, such as 2-way/Internet enabled text paging device 301, Internet/Wireless Application Protocol (WAP) enabled mobile phone 302, wireless PocketPC/Palm Pilot Internet enabled Personal Digital Assistant (PDA) using a wireless data network modem 303, or wireless LAN PocketPC/Palm Pilot device 304, that are equipped with tags. In embodiments of the invention, the tags are passive and have no internal power supply, but receive the required power source within reader/antenna monitoring zone 320. Alternatively, active tags, having internal power supply, may be used. The decision to use active tags is subject to the environmental conditions and application requirements, as known to a person of skill in the art.

In a preferred embodiment, passive tags are physically attached to wireless mobile devices, such as 2-way/Internet enabled text paging device 301, Internet/Wireless Application Protocol (WAP) enabled mobile phone 302, wireless PocketPC/Palm Pilot Internet enabled Personal Digital Assistant (PDA) using wireless data network modem 303, or wireless LAN PocketPC/Palm Pilot device 304. The invention may also use credit card tag 305, key ring tag 306, or other tag formats.

In an embodiment of the present invention, each RFID tag has a unique identifier assigned to it. RFID access point readers/antennas 370 installed at consumer entry/exit points 310 of a business create three-dimensional monitoring zones 320 which monitor entry/exit points 310 in order to detect RFID tags as they enter or exit the business. In embodiments, RFID access point readers/antennas 370 are also installed at various points throughout a business premises. These readers/antennas 370 are physically connected to a networked or non-networked RFID computer system 330. As monitoring zones 320 detect one or more tags, each tag is energized and triggered to emit identification signal 340. Reader/antenna 370 then detects identification signal 340 and transmits the tag data to RFID computer system 330 for further processing. Through this process, participating consumers are uniquely identified and can be associated to a specific location because the readers/antennas 370 are also assigned unique identifiers. RFID computer system 330 can then create a record reflecting the entry or exit event and the date and time it occurred.

If multiple readers/antennas 370 are required for a client location having more than one consumer entry/exit point 310, the readers/antennas can be daisy-chained together using an RS232 cable or other means, as known to those of skill in the art.

In embodiments of the present invention, the data protocol used by a tag is the same as that used by RFID computer system 330, and RFID computer system 330 automatically generates and transmits the event record to CTEP for further processing. In embodiments of the invention, the event record is compressed and encrypted during the generation process to ensure the data record can be authenticated by CTEP upon receipt.

In other embodiments, RFID computer system 330 is based on standard Microsoft Windows platforms and operating systems. The applications and processes designed and developed to implement the present invention use Microsoft compatible development tool kits, Application Programming Interfaces (APIs), and run-time execution environments.

Third-party vendor APIs compatible with the Microsoft systems may be used as needed. For example, in embodiments of the present invention, computer system 330 has software running on it to process the identification information transmitted by the tags. Such software is available from commercial RFID technology vendors, such as, AWID, RFID Inc., or Escort Memory Systems.

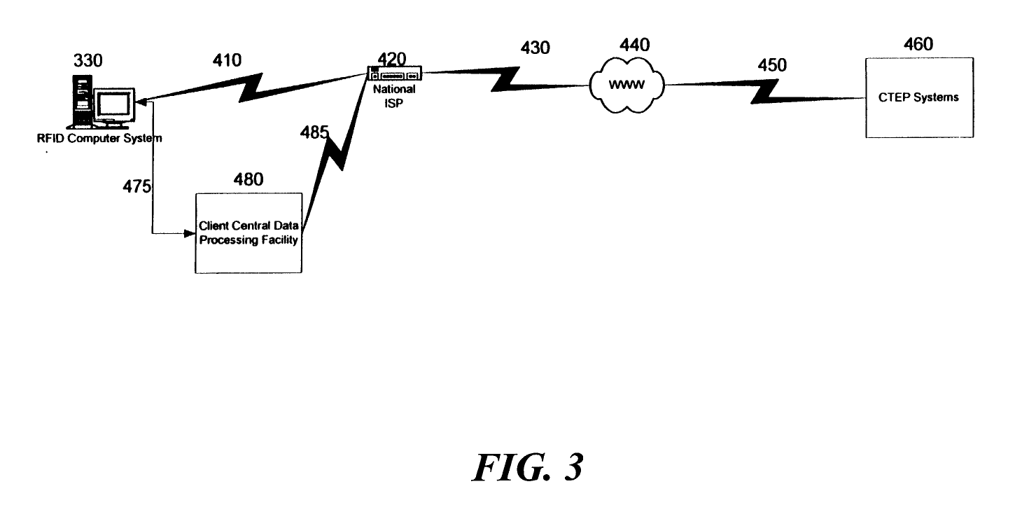

FIG. 3 illustrates a data communications infrastructure and system configuration of an embodiment of the present invention. From a networked or non-networked environment, RFID computer system 330 accesses Internet 440 using standard dial-up connection 410 to ISP 420 or another Internet connection service. The type and speed of connection 410 can reflect regular dial-up Internet access using a regular modem over a regular telephone line, a high speed Asymmetric Digital Subscriber Line (ADSL), a cable modem facilitating broadband connectivity, or other connections known to those of skill in the art. Alternatively, Internet 440 access could be provisioned using a wireless ISP. Alternatively, connection 475 may be achieved indirectly by using a business' own central data processing facilities 480 and network communications infrastructure. In such embodiments, from the business' centralized data facility 480, the information is sent to CTEP using an Internet connection 485 to national ISP 420.

Once ISP 420 receives the information, it facilitates connection 430 to Internet 440 and further routes the information over connection 450 to the appropriate Internet Protocol (IP) address associated with CTEP system 460.

In an embodiment of the present invention, the connection between RFID computer system 330 or central data processing facility 480 and CTEP system 460 requires both an authenticated connection and encrypted data transmission. For example, CTEP system 460 may be secured with Hyper Text Transport Protocol using Secure Socket layer connection (https). In embodiments of the invention, this specification invokes 128-bit encryption services from Verisign or other encryption services, to ensure that all subsequent communication between RFID computer system 330 or central data processing facility 480 and CTEP system 460 cannot be interpreted or manipulated by external sources.

In an embodiment of the present invention, upon establishing a secure connection with CTEP system 460, an automated login script is triggered from RFID computer system 330 or central data processing facility 480 to establish an authenticated connection to CTEP system 460. This login service is password authenticated using confidential client-id and password data known only to CTEP. Upon confirming this login request, the event record data transmission service can be invoked from RFID computer system 330 or central data processing facility 480.

Alternatively, connectivity between RFID computer system 330 and CTEP system 460 may be established using other telecommunication services and infrastructures that do not rely on any Internet based infrastructures and services. These solutions may include branch to branch long-distance service, frame-relay service, or other telecommunications services linking computer systems and/or LANs together over private and secure networks providing full-time connectivity, or other solutions as known to those of skill in the art.

Alternatively, CTEP system 460 could establish an inbound IVR system that could receive calls from RFID computer system 330. In an embodiment, upon generating the event record, the RFID computer system 330, configured with standard telephony hardware and software APIS, initiates an outbound call to a CTEP IVR system and communicates the event record data using touch tone digit signals over a common telephone line.

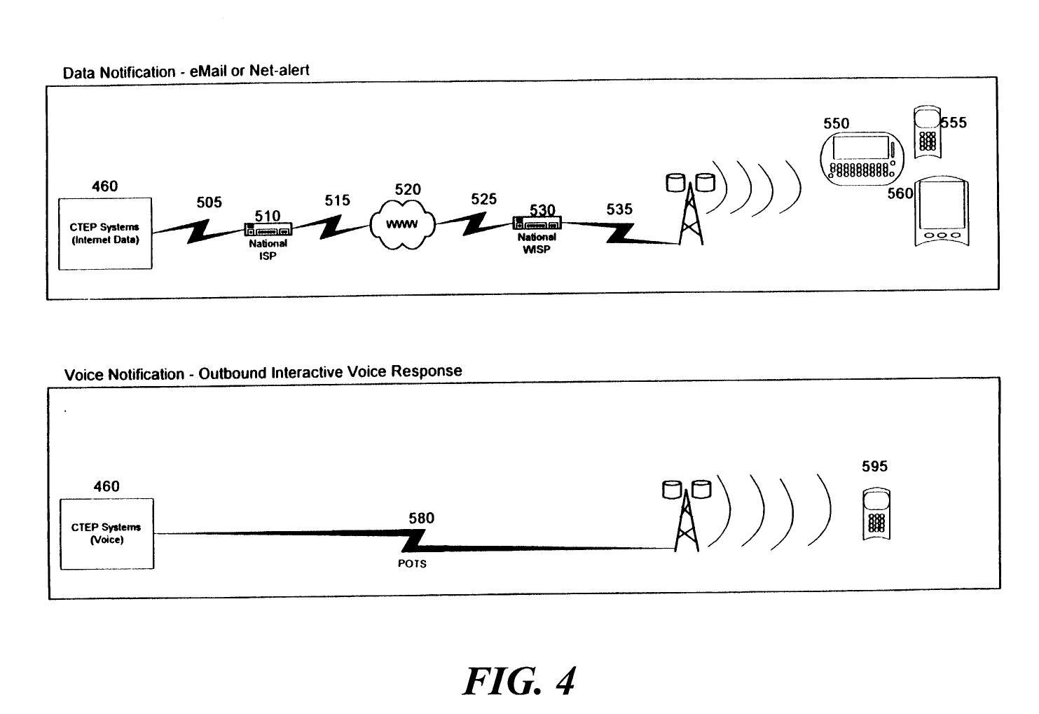

FIG. 4 illustrates data communications configurations of embodiments of the present invention. These data communications configurations may be utilized to send notification messages to participating consumers. In a preferred embodiment, subject to the profile and participation history of participating consumers, CTEP logic processing determines the method of notification a participating consumer should receive and whether the consumer should receive a survey or marketing/promotional information.

In an embodiment of the invention, CTEP system 460 has access to the Internet 520 via an active account and connection 505 to ISP 510. When connection 505 to ISP 510 is established, ISP 510 initiates connection 515 to Internet 520 and routes the connection to the appropriate wireless ISP 530. The destination URL is the address of the wireless ISP responsible for provisioning wireless mobile Internet service for the consumer's wireless mobile device, such as 2-way/Internet enabled text paging device 550, Internet/WAP enabled mobile phone 555, or wireless PocketPC/Palm Pilot Internet enabled PDA 560 using a wireless data network modem, or other devices known to those of skill in the art.

In an embodiment of the invention, CTEP system 460 uses wireless ISP 530 to transmit over wireless data channel 535 a notification text message, e-mail, or Net-Alert message, which supports embedded hot-links and/or embedded navigation options. The destination of the text message, e-mail, or Net-Alert is subject to the wireless mobile device assignment maintained in the panel member's profile data.

In an embodiment of the present invention, embedded hot-links/embedded navigation options ensure that the consumer can easily and quickly navigate back to the Internet site associated with CTEP system 460. Upon successful navigation to CTEP system 460, the consumer is presented a wireless survey and/or marketing/promotion material, tailored and personalized, for example, based on the consumer's location, demographic profile, and purchase history.

Subject to the notification profiles of participating consumers, in an embodiment of the present invention, CTEP system 460 may also trigger one or more outbound calls 580 to consumers upon detection of RFID events. For example, in an embodiment of the present invention, an IVR system within CTEP system 460 initiates outbound call scripts to participating consumers as appropriate. Connection to consumer wireless phone 595 may, for example, be accomplished using a standard wireless phone voice network. Upon connection, the appropriate customer survey script is initiated which may, for example, include a caller authentication script, to ensure the person answering the phone is the correct person, as well as a business-specific survey script.

An alternative method of notifying participating consumers of pending messages is to use standard paging services. If the wireless handheld device used by the consumer does not support paging functions, those participating consumers may be issued paging devices as appropriate. The paging service could be one-way, numeric, alphanumeric, or text-based or it could be 2-way numeric, alphanumeric, or text-based as needed. The messaging service may use SMS messaging or instant messaging, for example.

An alternative method for notifying participating consumers of pending marketing/promotions and/or surveys is to utilize interconnected LAN networks over private and secure non-Internet based telecommunications infrastructures and services. Assuming the business location has a wireless network, participating consumers may, for example, use wireless network-enabled handheld devices with appropriate application software installed on the devices. This software continually monitors for customer specific messages when in range of a wireless network signal. Upon message retrieval, a device alert notifying the consumer is issued.

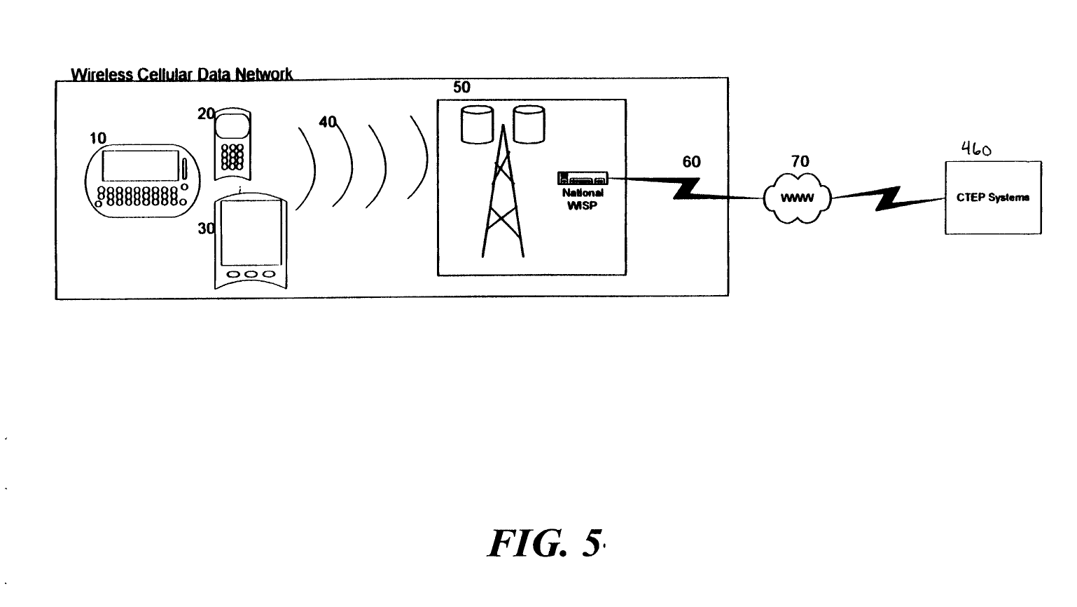

FIG. 5 illustrates a wireless data communications configuration of an embodiment of the present invention. The illustrated wireless mobile data communications configuration can be utilized by participating consumers to communicate with CTEP system 460.

Participating consumers may use wireless mobile devices, such as 2-way/Internet enabled text pager 10, such as a Research In Motions Blackberry 950, Internet-enabled wireless phone 20, such as a QualComm 2760 Personal Communications Service (PCS) phone, or hand held Personal Digital Assistant with a wireless modem 30, such as a Palm Pilot hand held organizer or a Casio PA-2400 equipped with a Sierra-AirCard 300 wireless data modem. In such embodiments, the consumers' wireless mobile devices are equipped to connect to the Internet using data channel 40 available on the wireless communication networks of any telecommunication service providers offering wireless Internet access 50, such as Sprint PCS, AT&T Wireless, GoAmerica. Upon establishing connection 40 to wireless ISP 50, connection to the Internet is achieved, providing wireless Internet connectivity to CTEP's wired and/or wireless Internet site.

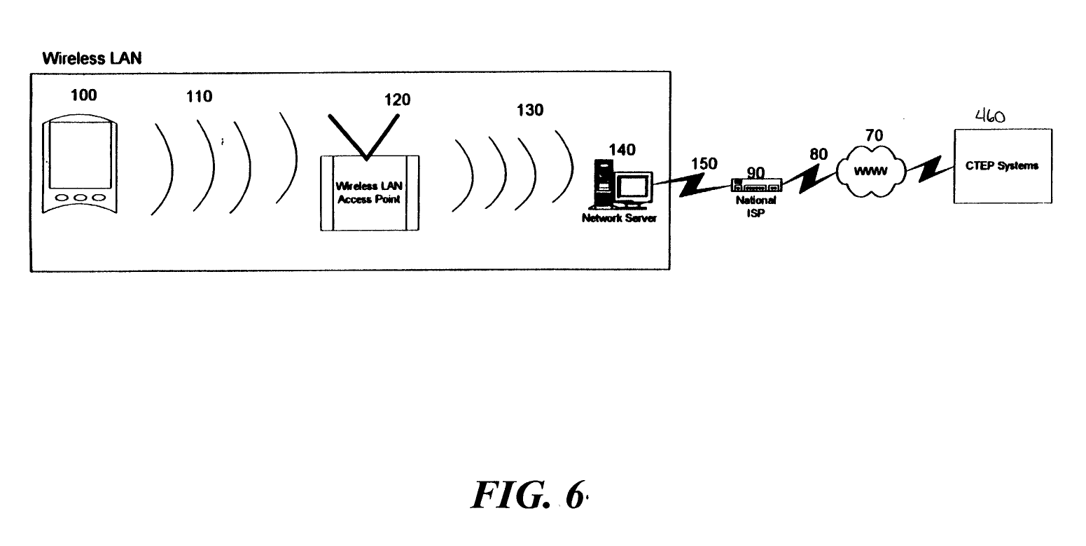

Alternatively, as depicted in FIG. 6, a wireless data communications configuration of an embodiment of the present invention utilizing a wireless Local Area Network (LAN) can be utilized to establish wireless mobile connectivity to CTEP. Wireless LAN enabled PDA 100 equipped with a wireless LAN card, such as a Casio PA-2400, could be used to establish and maintain connectivity to wireless network server 140 while in the coverage area of wireless LAN access points 120. The business location infrastructure may implement a wireless network solution, such as the capability offered by Symbol's Spectrum24 wireless LAN solution. As required with such networks, user privileges on wireless network server 140 are established in advance, and participating consumers log on to the network upon entering the wireless LAN coverage area. In an embodiment, upon achieving network connectivity, wireless network server 140 provides one or more connections 150 to ISP 90 facilitating connectivity 80 to the Internet. The consumer could then launch an Internet browser session on PDA 100 and navigate to the URL of CTEP system 460. Typical authentication processes are invoked prior to establishing the interactive Internet connection.

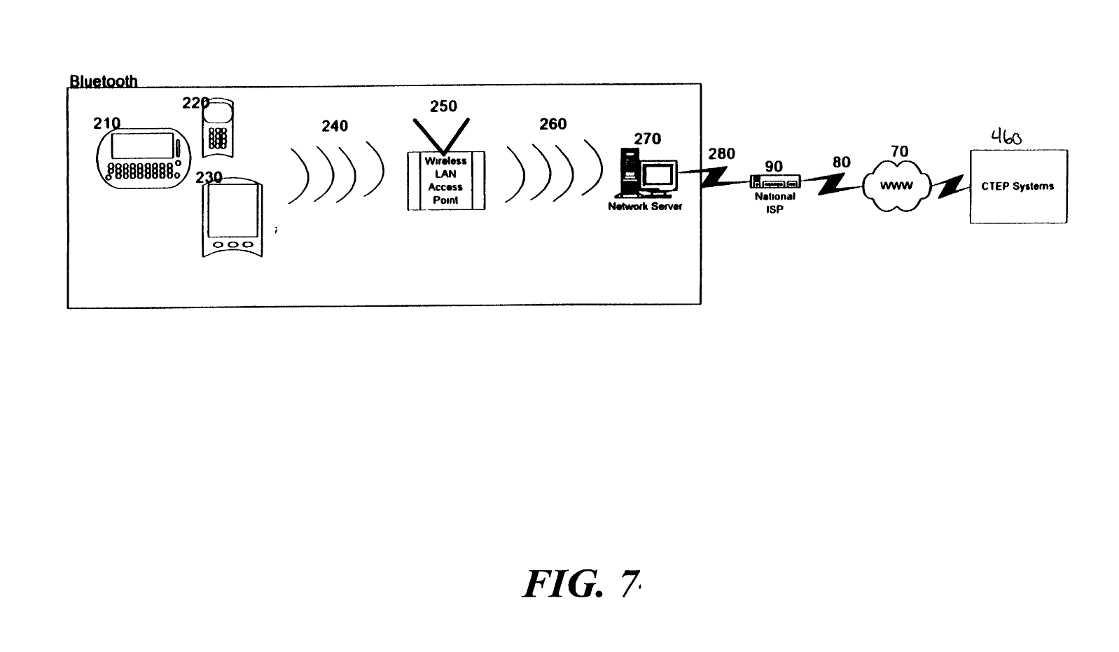

Alternatively, as depicted in FIG. 7, a wireless data communications configuration of an embodiment of the present invention utilizing a Bluetooth-enabled wireless LAN networking technology can be used to establish a connection to CTEP system 460. Wireless devices, such as 2-way/Internet enabled text paging device 210, Internet/WAP enabled mobile phone 220, or wireless PocketPC/Palm Pilot Internet enabled PDA 230 may connect to the Internet through ISP connection services using Bluetooth-enabled wireless network server 270. Bluetooth networking offers automated, wireless device recognition and connectivity to network 270 and its available services.

Bluetooth is an industry standard-setting organization founded by, among others, Ericsson, IBM, Intel, Nokia, and Toshiba, and refers to a short-range radio technology aimed at simplifying communications among Net devices and between devices and the Internet. It also aims to simplify data synchronization between Net devices and other computers. Products using Bluetooth technology are subject to interoperability testing by the Bluetooth Special Interest Group prior to release. The Bluetooth 1.0 specification consists of two documents: the Foundation Core, which provides design specifications, and the Foundation Profile, which provides interoperability guidelines.

The infrastructure needed to implement a Bluetooth wireless network solution may comprise wireless Bluetooth LAN Access Points 250 that transmit/route network requests over a wireless interface to and from the Bluetooth-enabled network server 270. To enable Bluetooth wireless connectivity, eligible CTEP wireless mobile devices are identified with unique device identifiers. Each unique device identifier is defined to the Bluetooth network as well as the specific privileges on the Bluetooth wireless network. In an embodiment of the present invention, when the wireless device enters the wireless LAN coverage area, it is automatically recognized, using the unique device identifiers, and granted appropriate access to wireless network server 270. In an embodiment, upon achieving network connectivity, network server 270 provides one or more connections 280 to ISP 90, facilitating connectivity 80 to the Internet. The participating consumer could then launch an Internet browser session via the various Bluetooth-enabled hand-held devices and navigate to the CTEP Internet site.

An alternative method of facilitating interactive communications between participating consumers and CTEP services is to employ a client/server solution approach.

Rather than launching an Internet browser session to connect to a CTEP URL over the Internet, the participating consumer could launch a custom application installed on an appropriately-enabled hand-held device. In such an embodiment of the present invention, the custom application establishes a connection to CTEP server applications over non-Internet based telecommunication infrastructures and services that create a private and secure network with full-time connectivity.

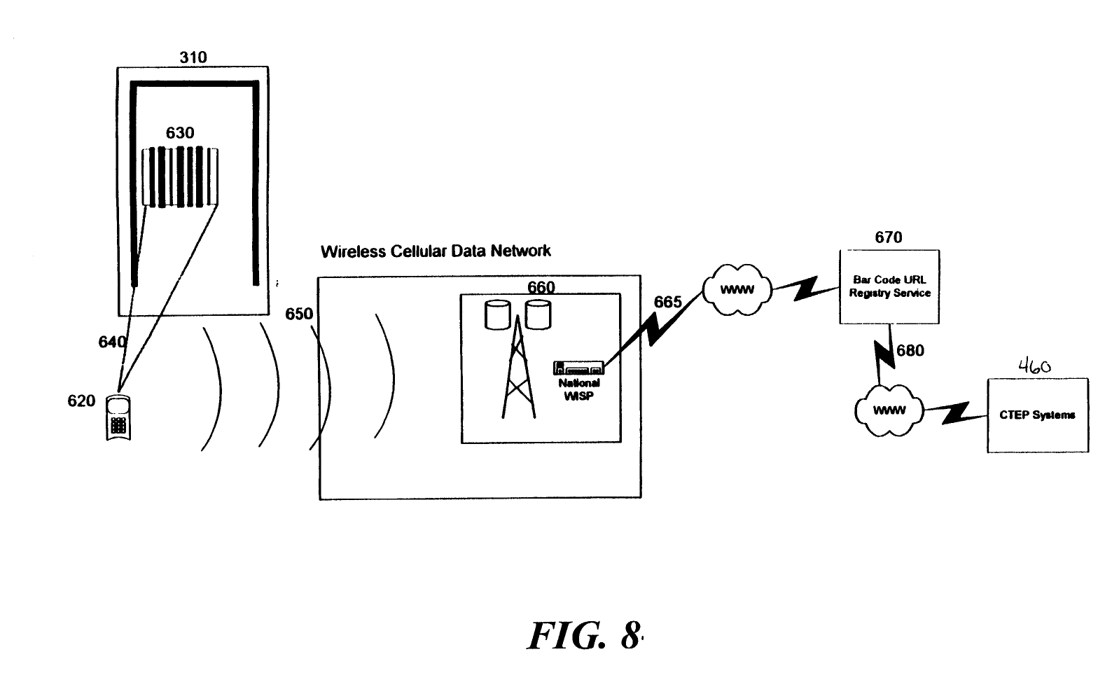

As an alternative to using RFID technology to detect and identify consumers, barcode-scanning technology may be employed to achieve a similar functionality. In an embodiment of the present invention illustrated in FIG. 8, consumers are equipped with wireless mobile device 620 having integrated scanning technology. A location-specific barcode label 630 having a specific destination URL/page associated with it is conveniently located at each entry/exit access point 310. In embodiments of the present invention, upon entry and exit, consumers are requested to scan barcode 630. In embodiments, location-specific barcode labels may be placed throughout a business premises for consumers to access promotions located in various areas within the premises.

In an embodiment, upon an entry scan event, the consumer's wireless device 620 automatically launches a micro-browser and initiates wireless Internet navigation and connectivity 650 to wireless ISP 660. Wireless ISP 660 then communicates with barcode/URL registry service 670 and transmits barcode label identification 630 and the Electronic Serial Number (ESN) associated to the consumer's wireless device 620 as parameters. Barcode/URL registry service 670 receives the request, determines the destination URL by cross-referencing its barcode registry using the barcode identification, and automatically routes the session to the appropriate site associated with CTEP system 460, passing the ESN along with it. In an embodiment, when this information reaches CTEP system 460, processing is initiated to generate a retail event record using the ESN to identify the consumer profile associated with the event.

Similarly, upon an exit scan event, wireless device 620 automatically launches a micro-browser and initiates wireless Internet navigation and connectivity 650 to wireless ISP 660. Wireless ISP 660 then communicates with barcode/URL registry service 670 and transmits barcode label identification 630 and the Electronic Serial Number (ESN) associated with the consumer's wireless device 620 as parameters. Barcode/URL registry service 670 receives the request, determines the destination URL by cross-referencing its barcode registry and automatically routes the session to the appropriate site associated with CTEP system 460, passing the ESN along with it. In an embodiment, when this information reaches CTEP system 460, processing is initiated to generate a retail event record using the ESN to identify the consumer profile associated with the event.

When an embodiment of the present invention uses integrated barcode scanning technology, the invention may also use the same decision process described by the text accompanying FIG. 1.

In another embodiment of the present invention, CTEP system 460 may also choose to initiate an interactive wireless Internet session with the consumer during the entry scan event and/or the exit scan event. In this instance CTEP system 460 makes sure the ESN is authorized to access CTEP system 460. When CTEP system 460 confirms that the ESN is an authorized CTEP consumer ESN, authentication services are invoked, and the consumer is prompted to enter a pass code. In an embodiment of the present invention, a valid combination of ESN and pass code identifies an authenticated consumer at which time an interactive session between the consumer and CTEP system 460 may begin. If the above scenario is employed, notification messaging, as described by the text accompanying FIG. 4, may be utilized.

While there have been shown and described specific embodiments of the present invention, it should be apparent to those skilled in the art that various changes and modifications may be made without departing from the scope of the invention or its equivalents. The invention is intended to be broadly protected consistent with the spirit and scope of the specification and the appended claims.

What is claimed is:

1. A method of communicating with a consumer comprising:
identifying a wireless identification device associated with the consumer at a premises; and
transmitting a message to a wireless reception device associated with the consumer, wherein content of the message is responsive to the premises' identity.

2. A method of communicating with a consumer comprising:
identifying a wireless identification device associated with the consumer at a premises; and
transmitting a message to a wireless reception device associated with the consumer, wherein content of the message is responsive to the premises' contents.

3. The method of claim 1 or claim 2, wherein the message comprises prompts to elicit information from the consumer relating to the premises.

4. The method of claim 1 or claim 2, wherein the message comprises a consumer satisfaction survey.

5. The method of claim 1 or claim 2, wherein the message comprises a product promotion.

6. The method of claim 1 or claim 2, wherein the message comprises a link to an Internet page.

7. The method of claim 1 or claim 2, wherein the message is an alphanumeric text message.

8. The method of claim 1 or claim 2, wherein the message is a voice message.

9. The method of claim 1 or claim 2, wherein the wireless identification device and the wireless reception device are the same device.

10. The method of claim 1 or claim 2, wherein identifying comprises:
detecting a Radio Frequency Identification Transponder at the premises.

11. The method of claim 10 further comprising:
transmitting Radio Frequency Identification Transponder information to a central controller.

12. The method of claim 1 1, wherein transmitting Radio Frequency Identification Transponder information to a central controller comprises:
accessing an Internet service provider; and
transmitting the Radio Frequency Identification Transponder information to the central controller using the Internet service provider.

13. The method of claim 11, wherein transmitting Radio Frequency Identification Transponder information to a central controller comprises:
accessing a wireless local area network; and
transmitting the Radio Frequency Identification Transponder information to the central controller using the wireless local area network.

14. The method of claim 11, wherein transmitting Radio Frequency Identification Transponder information to a central controller comprises:
accessing a Bluetooth-enabled wireless local area network; and
transmitting the Radio Frequency Identification Transponder information to the central controller using the Bluetooth-enabled wireless local area network.

15. The method of claim 1 or claim 2, wherein identifying comprises:
scanning a barcode.

16. The method of claim 1 or claim 2, wherein transmitting comprises:
accessing a wireless Internet service provider; and
transmitting the message to the wireless reception device.

17. The method of claim 1 or claim 2, wherein transmitting comprises:
accessing a telecommunications services provider; and
transmitting the message to the wireless reception device through the telecommunications services provider.

18. The method of claim 1 or claim 2 further comprising:
receiving a response to the message.

19. The method of claim 18, wherein receiving comprises:
accessing an Internet service provider; and
receiving the response to the message.

20. The method of claim 18, wherein the response comprises a text message.

21. The method of claim 18, wherein the response comprises a voice message.

22. A system for communicating with a consumer comprising:
a wireless identification device associated with a consumer at a premises;
a wireless identification device detector to communicate with the wireless identification device;
a first computer in communication with the wireless identification device detector for identifying the consumer associated with of the wireless identification device;
a wireless reception device associated with the consumer; and
a second computer in communication with the first computer, for transmitting a message to the wireless reception device, wherein content of the message is responsive to the premises' identity or responsive to the premises' contents.

23. The system of claim 22, wherein the message comprises prompts to elicit information from the consumer relating to the premises.

24. The system of claim 22, wherein the message comprises a consumer satisfaction survey.

25. The system of claim 22, wherein the message comprises a product promotion.

26. The system of claim 22, wherein the message comprises a link to an Internet page.

27. The system of claim 22, wherein the message is an alphanumeric text message.

28. The system of claim 22, wherein the message is a voice message.

29. The system of claim 22, wherein the wireless identification device and the wireless reception device are the same device.

30. The system of claim 22, wherein the first computer and the second computer comprise the same computer.

31. The system of claim 22, wherein the first computer and the second computer communicate using an Internet service provider.

32. The system of claim 22, wherein the first computer and the wireless identification device detector are the same device.

33. The system of claim 22, wherein the wireless identification device and the wireless identification device detector communicate using a wireless local area network.

34. The system of claim 22, wherein the wireless identification device and the wireless identification device detector communicate using a Bluetooth-enabled wireless local area network.

35. The system of claim 22, wherein the wireless identification device and the wireless identification device detector communicate using an Internet service provider.

36. The system of claim 22, wherein the second computer receives a response to the message.
